(19) United States
(12) Patent Application Publication
(10) Pub. No.: US 2017/0268752 A1
(43) Pub. Date: Sep. 21, 2017

(54) Illumination Systems with LED-Based Extension Light Source

(71) Applicant: Amerillum LLC, Oceanside, CA (US)

(72) Inventors: Justin L. Horvath, Oceanside, CA (US); Ronald S. Lancial, Oceanside, CA (US)

(21) Appl. No.: 15/073,490

(22) Filed: Mar. 17, 2016

(51) Int. Cl. F21V 19/00

(52) U.S. Cl. CPC F21V 19/003; F21Y 2103/10

(57) ABSTRACT

An illumination system includes an LED-based light source that is elongated along a given direction and has a target length. The LED-based light source includes two or more boards disposed along the given direction, each of the boards corresponding to a stockkeeping unit (SKU) from among a finite number of SKUs. Here, each SKU corresponds to a combination of a pre-specified board length and an LED circuit to be powered using a constant current method. As a value of the target length of the LED-based light source is smaller than a sum of the lengths of the constitutive boards of the LED-based light source, a shortest board from among the constitutive boards is offset, in a direction orthogonal to the given direction, by a finite offset relative to the remaining ones of the constitutive boards.

### FIELD OF THE DISCLOSURE

Illumination systems described herein include a light-emitting diode (LED)-based extension light source to accommodate a target length of the illumination systems.

### BACKGROUND

Many types of electric light sources, such as, incandescent lamps, fluorescent lamps, compact fluorescent lamps (CFL), cold cathode fluorescent lamps (CCFL), high-intensity discharge lamps have been used for general illumination purposes. The foregoing types of electric light sources are gradually being replaced in many general illumination applications by solid state light sources, e.g., light-emitting diodes (LEDs).

Development of LED-based illumination systems, e.g., LED-based pendant lighting fixtures or LED-based troffer lighting fixtures, has focused on ways to output as much of the light emitted by the LEDs as possible into the ambient.

### SUMMARY

According to an aspect of the disclosed technologies, an illumination system includes a housing; a mount arranged inside the housing and elongated along a first direction, the mount having a first end and a second end separated along the first direction by a total length; a first substrate having a first length shorter than the total length, the first substrate being coupled with the mount along the first direction such that an end of the first substrate aligns with the first end of the mount, the first substrate supporting a first circuit that includes light emitting diodes (LEDs) and a current regulator connected in series with each other, the LEDs of the first circuit being distributed along the first direction over the first length and disposed on the first substrate to emit, when the illumination system is operated, light in a second direction orthogonal to the first direction, the current regulator of the first circuit being configured to provide, when the illumination system is operated, constant current to the LEDs of the first circuit; a second substrate having a second length longer than a difference between the total length and the first length, the second substrate being coupled with the mount (i) along the first direction such that an end of the second substrate aligns with the second end of the mount, and (ii) offset by a finite offset relative to the first substrate along the second direction, the second substrate supporting a second circuit that includes LEDs and a current regulator connected in series with each other, the LEDs of the second circuit distributed along the first direction over the second length and disposed on the second substrate to emit, when the illumination system is operated, light in the second direction, the current regulator of the second circuit being configured to provide, when the illumination system is operated, current regulation in the second circuit; and a lens supported by the housing and extending along the first direction between the first and second ends of the mount, the lens being spaced apart, along the second direction, from the LEDs of the first circuit by a predefined spacing.

The foregoing and other embodiments can each optionally include one or more of the following features, alone or in combination. In some implementations, the finite offset can be negative such that a portion of the first substrate distal from the first end of the housing is (A) between the lens and a portion of the second substrate distal from the second end of the housing over an overlap distance along the first direction, the overlap distance being equal to a difference between (i) the sum of the first length and the second length and (ii) the total length, and (B) blocks, during operation of the illumination system, light emitted by a set of the LEDs of the second circuit—that are distributed over the overlap distance of the second substrate—from reaching the lens. In some implementations, the finite offset can be positive such that a portion of the second substrate distal from the second end of the housing (A) is between the lens and a portion of the first substrate distal from the first end of the housing over an overlap distance along the first direction, the overlap distance being equal to a difference between the sum of the first length and the second length and the total length, and (B) blocks, during operation of the illumination system, light emitted by a set of the LEDs of the first circuit—that are distributed over the overlap distance of the first substrate—from reaching the lens.

In some implementations, the illumination system can include an optical coupler arranged inside the housing and elongated along the first direction, the optical coupler being disposed along the second direction between the first substrate and the lens, and optically coupled with at least some of the LEDs of the first circuit. In some cases, the optical coupler can extend between the first and second ends of the mount. In other cases, the optical coupler extends from the first end of the mount over the first length of the first substrate. In either of the foregoing cases, the optical coupler is optically coupled with the lens.

In some implementations, the illumination system can include a first tray disposed on the mount, the first substrate being disposed on the first tray; and a second tray disposed on the mount, the second substrate being disposed on the second tray. Here, a height offset of the first and second trays is equal to the finite offset.

In some implementations, the lens can include a material transparent to the light emitted by the LEDs of the first and second circuits. In some implementations, the lens can have finite optical power.

According to another aspect of the disclosed technologies, a method includes determining, from among a plurality of pre-specified light emitting diode (LED) board lengths of LED boards, two or more combinations of pre-specified LED board lengths, each of the LED boards including a corresponding LED circuit to be powered in constant current delivery method. Here, each of the determined combinations includes an associated first number of LED boards of a first pre-specified LED board length and an associated second number of LED boards of a second pre-specified LED board length, and has a combined length that is larger than a target length of a mount, such that a difference between the combined length and the target length is smaller than a shorter of the first pre-specified LED board length and the second pre-specified LED board length. Further here, each of the LED boards of the determined combination is to be coupled with the mount along a first direction. The method further includes selecting, from among the determined combinations, an optimum combination that meets an optimization criterion; and coupling the LED boards of the optimum combination with the mount. Here, an LED board having the shorter of the first pre-specified LED board length and the second pre-specified LED board length is offset by a finite offset along a second direction orthogonal to the first direction with respect to the remaining LED boards of the optimum combination.

The foregoing and other embodiments can each optionally include one or more of the following features, alone or in combination. In some implementations, the optimization criterion can include maximizing the difference between the combined length of the optimum combination and the target length. In some implementations, the optimization criterion can include minimizing the difference between the combined length of the optimum combination and the target length.

In some implementations, the operation of coupling the LED boards of the optimum combination with the mount can include (i) supporting the offset LED board on a first tray coupled with the mount, and (ii) supporting the remaining LED boards of the optimum combination on a second tray coupled with the mount, wherein a separation of the first tray from the mount is smaller than a separation of second tray from the mount by the finite offset, and wherein a portion of the first tray is between a portion of the second tray and the mount.

In some implementations, the method can include determining that the optimum combination is not available in stock; and selecting, from among the determined combinations, a next optimum combination that meets the optimization criterion. Here, the operation of coupling the LED boards of the optimum combination with the mount is performed using the selected next optimum combination.

Particular aspects of the disclosed technologies can be implemented so as to realize one or more of the following potential advantages. For example, standard length (and therefore electrical load) LED boards, that include LED circuits operable in constant current mode, can be used in an LED-based light source, in accordance with the disclosed systems and methods, to achieve luminaire lengths of desired accuracy, while taking advantage of the most efficient method of driving the LED circuits. In this manner, architects and lighting designers who use the disclosed technologies can design an LED-based luminaire that outputs a continuous line of light that spans from one location to another without regard to what that resulting luminaire length will be, while using a constant current method of delivering power to the LED circuits.

Further, the disclosed technologies can be used to reduce complexity of (1) procurement of LED boards operable in constant-current mode, and (2) assembly of such LED boards in LED-based light sources. As such, given a finite number of stockkeeping units (SKUs) for LED boards (and, hence, a finite number of lengths for the LED boards), an additional allowance of flexibility is provided by the disclosed systems and methods since customers are given the freedom to specify any suitable length of product. Furthermore, overlapping portions of LED boards in LED-based light sources, in accordance with the disclosed technologies, ensures obtaining an LED-based luminaire of target length while allowing the number of SKUs to remain low.

Details of one or more implementations of the disclosed technologies are set forth in the accompanying drawings and the description below. Other features, aspects, descriptions and potential advantages will become apparent from the description, the drawings and the claims.

### BRIEF DESCRIPTION OF THE DRAWINGS

FIG. 1 shows an example of a luminaire including an illumination system that uses an LED-based extension light source.

FIGS. 2A-2C show respective examples of an illumination system that uses an LED-based extension light source.

FIG. 3 shows an example of an LED board that can be powered in constant current mode.

FIGS. 4A-4B show aspects of a first example of an LED-based extension light source.

FIGS. 4C-4D show aspects of a second example of an LED-based extension light source.

FIG. 5 shows an example of a method for forming an LED-based extension light source like the one in FIGS. 4A-4B.

Certain illustrative aspects of the illumination systems according to the disclosed technologies are described herein in connection with the following description and the accompanying figures. These aspects are, however, indicative of but a few of the various ways in which the principles of the disclosed technologies may be employed and the disclosed technologies are intended to include all such aspects and their equivalents. Other advantages and novel features of the disclosed technologies may become apparent from the following detailed description when considered in conjunction with the figures.

### DETAILED DESCRIPTION

Illumination systems disclosed herein include an LED-based light source that is elongated along a given direction (e.g., along the y-axis) and has a target length. The disclosed LED-based light source includes two or more boards disposed along the given direction, each of the boards corresponding to a SKU from among a finite number of SKUs. Here, each SKU corresponds to a combination of a predefined board length and an LED circuit to be powered using a constant current method. As a value of the target length of the disclosed LED-based light source is smaller than a sum of the lengths of the constitutive boards of the LED-based light source, a shortest board from among the constitutive boards is offset, in a direction orthogonal to the given direction (e.g., along the z-axis), by a finite offset relative to the remaining ones of the constitutive boards. Note that the disclosed LED-based light source is also referred to as an LED-based extension light source. An illumination system with such an LED-based extension light source can be included in a luminaire, for instance, as described below.

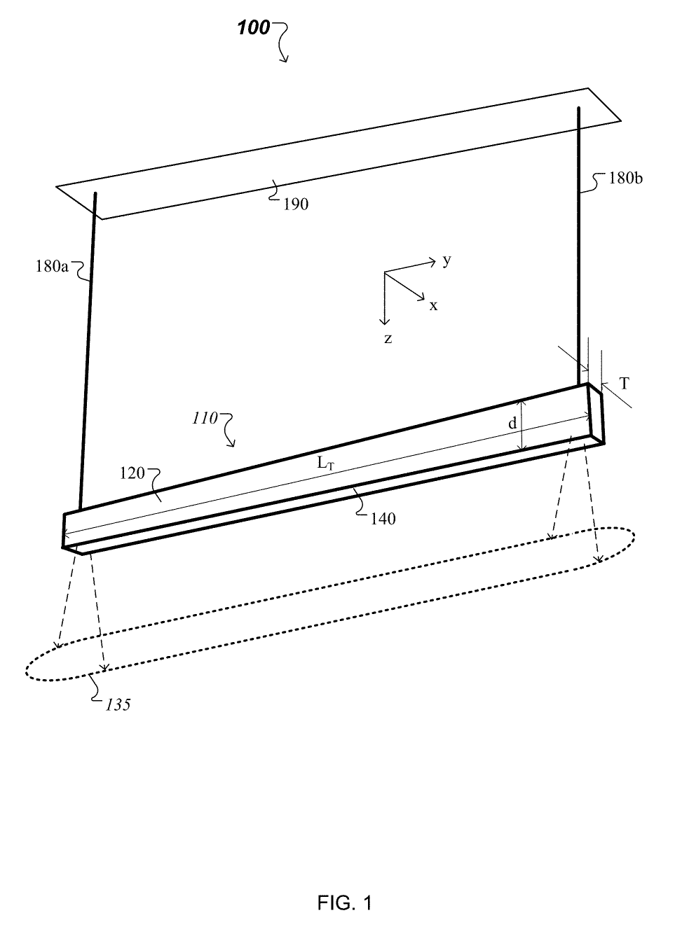

FIG. 1 shows an example of a luminaire 100 including an illumination system 110 and cables 180a, 180b. Here, the illumination system 110 is suspended from a ceiling 190 by the cables 180a, 180b. The illumination system 110 includes a housing 120 and an LED-based extension light source. In this example, the housing 120 of the illumination system 110 is elongated along the y-axis over a target length L_{T}, has a thickness T along the x-axis and a depth d along the z-axis. The target length can be L_{T}=0.5″, 1″, 2″, 3″, 5″, 11″, 13″, 17″, etc., or any other suitable luminaire lengths. The illumination system 110 outputs, e.g., through a lens 140 of the LED-based extension light source, to an ambient environment (e.g., to a target surface—not shown in FIG. 1), output light in an output angular range 135. Here, the prevalent propagation direction of the output light is along the z-axis.

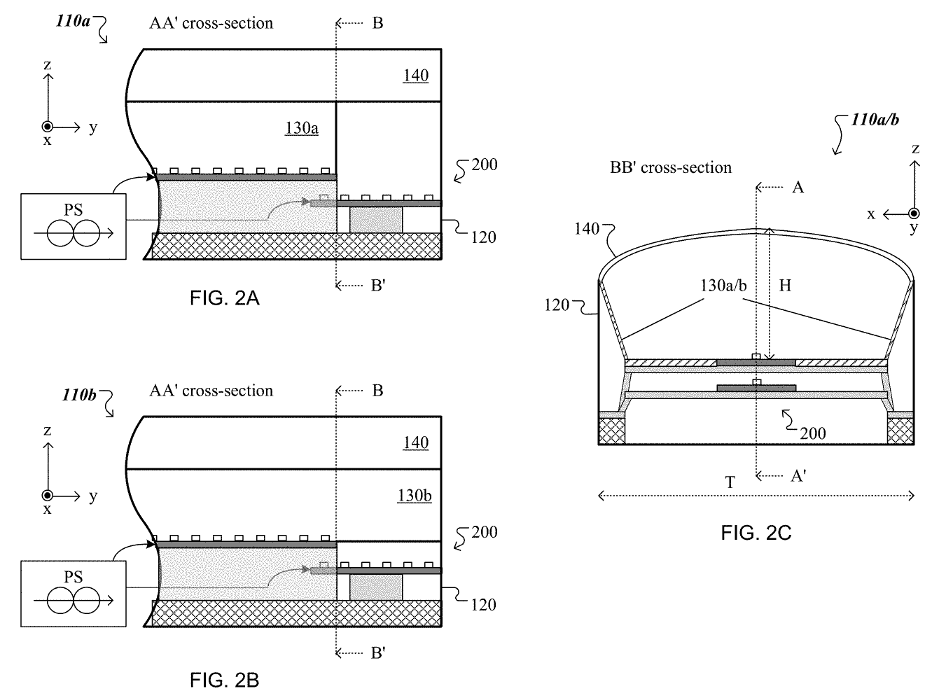

FIGS. 2A and 2B show a portion of a longitudinal cross-section in the y-z plane of respective examples 110a and 110b of the illumination system from FIG. 1. FIG. 2C shows a transverse cross-section in the x-z plane of each of the illumination systems 110a and 110b. Here, each of the illumination systems 110a and 110b includes the housing 120, an LED-based extension light source 200, a respective optical coupler 130a and 130b, and a lens 140. LEDs of the LED-based extension light source 200 are powered using a power source (PS) that uses a constant current method of delivering power.

Note that light emitted, e.g., along the z-axis, by at least some of the LEDs of the LED-based extension light source 200 of each of the illumination systems 110a and 110b is collimated by the respective optical coupler 130a and 130b such that a divergence of the collimated light is smaller than a divergence of the emitted light. The lens 140 transmits, e.g., along the z-axis, the collimated light to an ambient environment as output light. As the lens 140 has finite (non-zero) optical power, the output light can have a divergence that is different from the divergence of the collimated light. In the examples illustrated in FIGS. 1 and 2C, the thickness T of the illumination systems 110, 110a and 110b can be T=2″, 3.5″ or 5″, for instance.

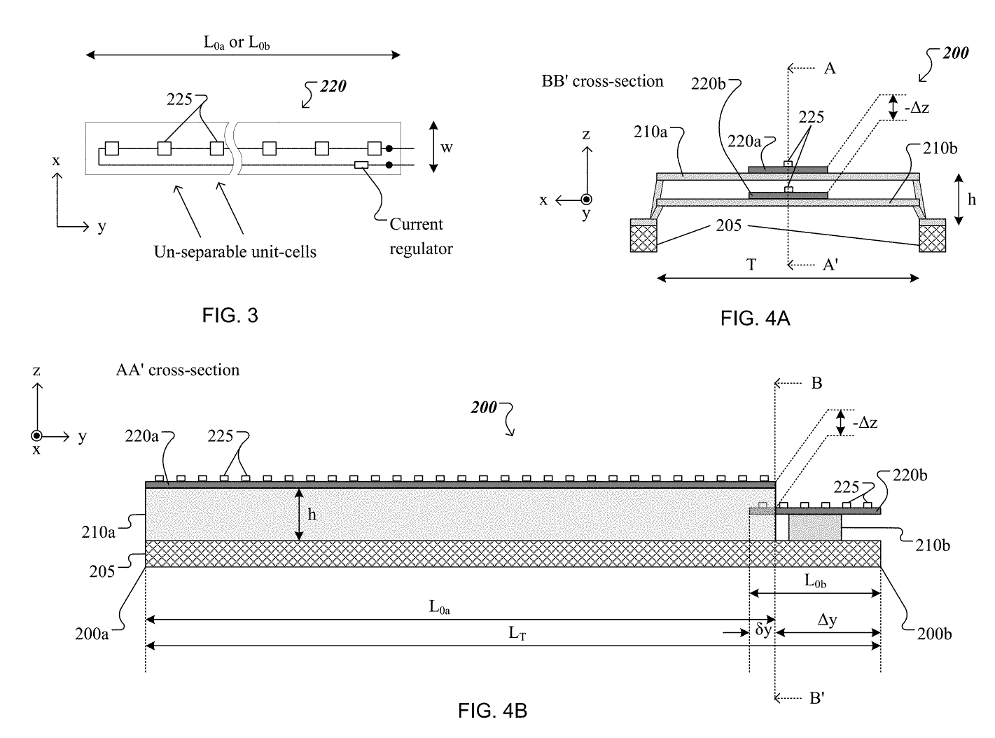

FIG. 3 shows an example of a substrate (also referred to as a board) that supports a plurality of LEDs 225 that are equally spaced and distributed along the length of the board, e.g., along the y-axis. The LEDs 225 are connected to each other in series as part of an LED circuit that includes a current regulator, such that the LEDs are powered using a constant current method of delivering power (e.g., also referred to as powered in current regulation mode) when the LED circuit is coupled with a power supply. In this manner, during operation of each of the illumination systems 110, 110a and 110b, the current regulator maintains a constant current in the series LED circuit powered by the power supply. The board together with the LED circuit supported on it are referred to as an LED board 220. A width w of the LED board 220 is pre-specified. For instance, values of the LED board widths can be 0.4″, 0.5″, 0.6″, etc. A length L₀ of the LED board 220 (e.g., L₀ₐ, L_{0b}, etc.) also is pre-specified. For instance, values of the LED board lengths can be 5″, 12″, 17″, etc. In this manner, because an LED density of an LED board is typically constant, e.g., 1 LED/inch, 2 LEDs/inch, etc., a number of the equally spaced LEDs of the LED board 220 also is pre-specified. An LED board 220 that has a pre-specified number N₀ of LEDs or equivalently with a pre-specified length L₀ can be procured/ordered based on SKUs, for instance. Notably, an LED board 220 with LEDs to be powered in current regulation mode and that has a pre-specified length, e.g., L_{0b}, cannot be cut (shortened) to a desired, smaller length, e.g., L₁<L_{0b}. Equivalently, the foregoing LED board 220 that has a pre-specified number N_{0b} of LEDs to be powered in current regulation mode cannot be cut (shortened) to remove a desired number of LEDs from N_{0b}.

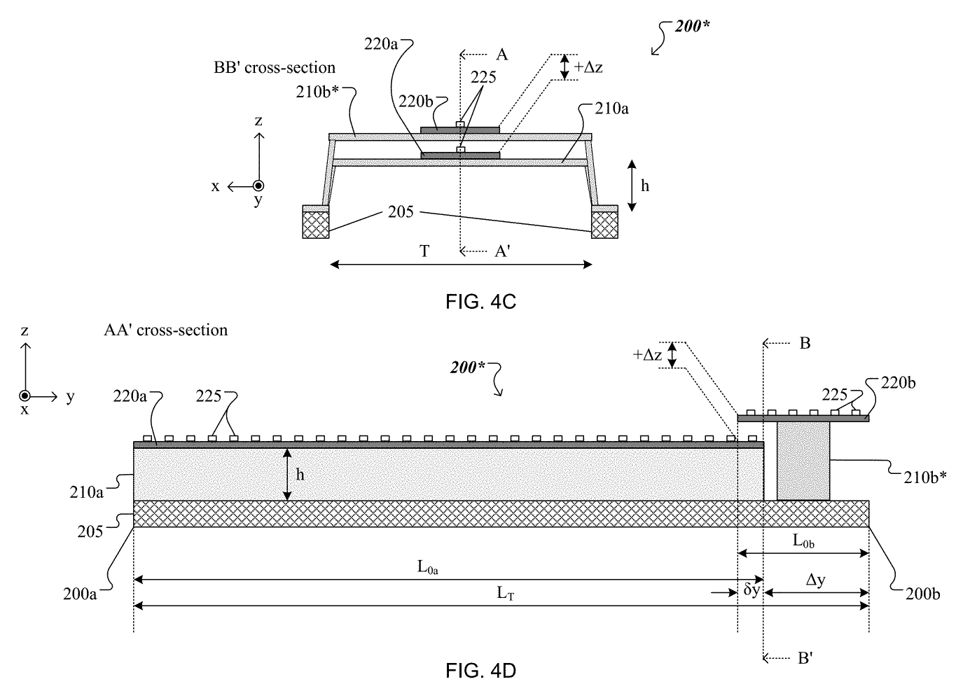

FIG. 4A shows a transverse cross-section (e.g., in the x-z plane) and FIG. 4B shows a longitudinal cross-section (e.g., in the y-z plane) of a first example of an LED-based extension light source 200, where the LED-based extension light source 200 has a target (total) length L_{T}. FIG. 4C shows a transverse cross-section (e.g., in the x-z plane) and FIG. 4D shows a longitudinal cross-section (e.g., in the y-z plane) of a second example of an LED-based extension light source 200*, where the LED-based extension light source 200* has a target length L_{T}. In these examples, each of the LED-based extension light sources 200 and 200* includes a first LED board 220a having a first length L₀ₐ. The first LED board 220a includes a first LED circuit with a current regulator and N₀ₐ LEDs 225 connected in series to each other and the current regulator. Each of the LED-based extension light sources 200 and 200* further includes a second LED board 220b having a length L_{0b}. The second LED board 220b includes a second LED circuit with a current regulator and N_{0b} LEDs 225 connected in series to each other and the current regulator. As noted in connection with FIG. 3, neither the first LED board 200a nor the second LED board 200b can be shortened to a desired length. In the examples illustrated in FIGS. 4A-4B and 4C-4D, the length of the first LED board 220a is longer than the length of the second LED board 220b, L₀ₐ>L_{0b}, and a sum of the length of the first LED board 220a and the length of the second LED board 220b is larger than the target length of each of the LED-based extension light sources 200 and 200*, L₀ₐ+L_{0b}>L_{T}.

Each of the LED-based extension light sources 200 and 200* further includes a mount 205 and a first tray 210a. The LED-based extension light source 200 also includes a second tray 210b, and the LED-based extension light source 200* also includes a second tray 210b*. The mount 205 has a length L_{T} along the y-axis equal the target length of each of the LED-based extension light sources 200 and 200* and can be used to (i) support the first tray 210a and the respective second tray 210b or 210b*, and (ii) attach the LED-based extension light source to the housing 120 of the illumination system 100 or 110a. In the examples illustrated in FIGS. 4A-4B and 4C-4D, the mount 205 can be formed from a pair of rails spaced apart from each other by a distance smaller than or equal to the width T of the housing 120. Here, each of the trays is attached to the rails of the mount 205 using various fastening means, e.g., pin-to-hole mating, snap-in fastening, bolting, etc.

The first tray 210a supports the first LED board 220a spaced apart from the mount 205 at a level along the z-axis (e.g., at z=0) that is determined by a value of the first tray's height h, such that the LEDs 225 of the first LED board are separated from the lens 140 by a separation H, as shown in FIG. 2C. Each of the second trays 210b and 210b* supports the second LED board 220b spaced apart from the mount 205 at another level that is offset by Δz along the z-axis relative to the predetermined level of the first board 220a. A value of the offset Δz is a fraction f of the first tray 210a's height h, Δz=fh, where f 5%, 10%, 20%, 50%, or other fractions. Here, each of the LED boards is attached to its corresponding supporting tray using various fastening means, e.g., pin-to-hole mating, snap-in fastening, adhesive fastening, bolting, etc.

As such, in the example illustrated in FIGS. 4A-4B, a height of the second tray 210b, relative to the mount 205, is smaller than a height h of the first tray 210a by Δz, such that the second LED board 220b supported by the second tray is lowered by Δz (or displaced by a negative offset −Δz) from the first LED board 220a supported by the first tray. In the example illustrated in FIGS. 4C-4D, a height of the second tray 210b*, relative to the mount 205, is larger than a height h of the first tray 210a by Δz, such that the second LED board 220b supported by the second tray is raised by Δz (or displaced by a positive offset +Δz) from the first LED board 220a supported by the first tray.

Note that, in the examples illustrated in FIGS. 4A-4B and 4C-4D, while a length (e.g., along the y-axis) of the first tray 210a is equal to or smaller than the length L₀ₐ of the first LED board 220a, a length (e.g., along the y-axis) of each of the second trays 210b and 210b* is smaller than or equal to an extension length Δy, defined as the difference between the target length of each of the LED-based extension light sources 200 and 200* and the length of the first LED board, Δy=L_{T}−L₀ₐ. Moreover, the first LED board 220a supported by the first tray 210a is aligned with a first end 200a of the mount 205, and the second LED board 220b supported by the respective second tray 210b and 210b* is aligned with a second end 200b of the mount. In this manner, the first LED board 220a and the second LED board 220b are offset along the z-axis by Δz, and adjacent end portions of the first LED board and the second LED board overlap by an excess length δy along the y-axis, where δy=(L₀ₐ+L_{0b})−L_{T}. For this reason, the excess length δy also is referred to as on overlap distance. Note that there are one or more LEDs 225 disposed within the overlapping end portions of the first and second LED boards 220a, 220b. For example, in FIGS. 4A-4B, a subset of LEDs 225 disposed within the overlapping end portion of the second LED board 220b are below the overlapping end portion of the first LED board 220a, such that light emitted by this subset of LEDs is obstructed from directly reaching the optical coupler 130 and the lens 140 when the LED-based extension light source 200 was included in one of the illumination systems 110a or 110b. As another example, in FIGS. 4C-4D, another subset of LEDs 225 disposed within the overlapping end portion of the first LED board 220a are below the overlapping end portion of the second LED board 220b, such that light emitted by this other subset of LEDs is obstructed from directly reaching the optical coupler 130 and the lens 140 if the LED-based extension light source 200* was included in one of the illumination systems 110a or 110b.

Referring again to FIGS. 2A-2B, note that the lens 140 extends over the target length L_{T} of the extension light source 200. However, FIG. 2A shows that the optical coupler 130a of the illumination system 110a extends only over the length L₀ₐ of the first LED board 220a of the extension light source 200. In this manner, light emitted, e.g., along the z-axis, by the LEDs of the first LED board 220a is collimated by the optical coupler 130a before it reaches the lens 140, while light emitted by the LEDs of the second LED board 220b that are unobstructed by the back of the first LED board reaches the lens without collimation.

Alternatively, FIG. 2B shows that the optical coupler 130b of the illumination system 110b extends over the target length L_{T} of the extension light source 200. In this manner, light emitted by the LEDs of the first LED board 220a is collimated by the optical coupler 130b before it reaches the lens 140, and light emitted, e.g., along the z-axis, by the LEDs of the second LED board 220b that are unobstructed by the back of the first LED board may be at least partially collimated by the optical coupler 130b before it reaches the lens 140. Note that in either of the implementations 110a and 110b of the illumination system, the combination of the lens 140 and respective optical coupler 130a or 130b is configured such that the output light provided by the illumination system is optimized for light emitted by LEDs of the extension light source 200 that are spaced apart from the lens by a specified separation H. For this reason, the first LED board 220a—which has a number N₀ₐ of LEDs that is larger than the number N<N_{0b} of unobstructed LEDs of the second LED board 220b—is separated from the lens 140 by the specified separation H.

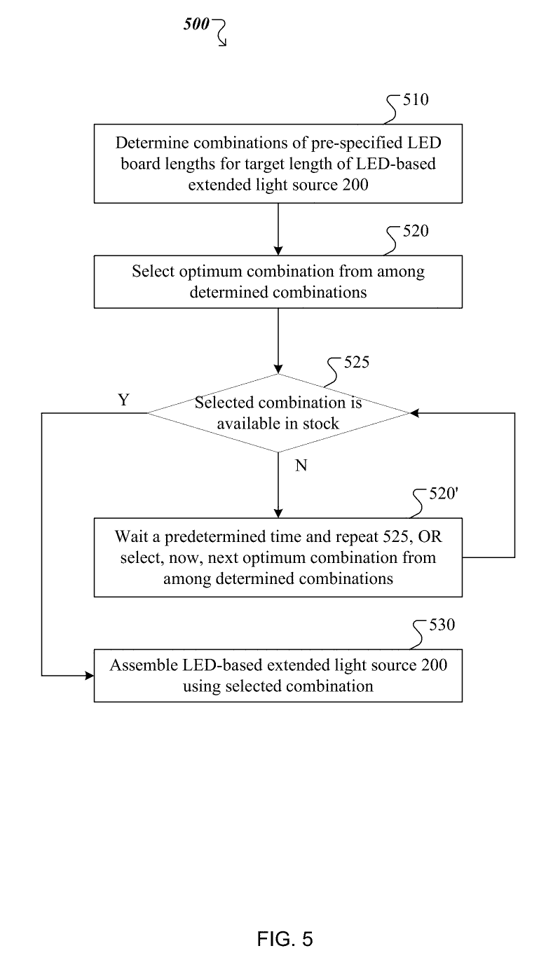

FIG. 5 shows a method 500 for selecting a combination of LED boards from among a stock (or inventory) of available LED boards having pre-specified LED board lengths for assembling an LED-based extension light source 200, like the one shown in FIG. 4B. For example, a target total length of the length of the LED-based extension light source 200 is specified by an architect or lighting designer to be L_{T}, and the available LED board SKUs correspond to pre-specified LED board lengths of L₀ₐ and L_{0b}, where L₀ₐ>L_{0b}, for instance.

At 510, combinations of the pre-specified LED board lengths are determined that have a combined length (nₐL₀ₐ+n_{b}L_{0b}) that is longer than the target total length L_{T} by less than a minimum of the lengths of the available pre-specified LED board lengths, here L_{0b}. So, a combination of a number nₐ of “long” LED boards having pre-specified length L₀ₐ and a number n_{b} of “short” LED boards having pre-specified length L_{0b} has to satisfy the inequality: (nₐL₀ₐ+n_{b}L_{0b})−L_{T}<L_{0b}. Table 1 shows the determined combinations that satisfy the foregoing inequality for L_{T}=28″; L₀ₐ=12″; and L_{0b}=5″.

TABLE 1
Combinations for L_{T} = 28″; L₀ₐ = 12″ and L_{0b} = 5″

| nₐ | n_{b} | δy = [(nₐL₀ₐ + n_{b}L_{0b}) − L_{T}] < L_{0b} | Δy = L_{0b} − δy |
|---|---|---|---|
| 2 | 1 | 1″ | 4″ |
| 1 | 4 | 4″ | 1″ |
| 0 | 6 | 2″ | 3″ |

Any of the combinations of long LED boards of length L₀ₐ, and short LED boards of length L_{0b} from Table 1 can be used to assemble the LED-based extension light source 200 of target length L_{T}=28″. Note that the excess length δy, represented in the third column of Table 1, is a first portion of a short LED board of length L_{0b} that will be disposed between a neighboring board and the mount 205, such that a first set of LEDs 225 distributed on this first portion will be obstructed by the back of the neighboring board, as shown in the example illustrated in FIG. 4B. In this manner, light emitted by the first set of LEDs 225 distributed on the first portion will not directly propagate to the lens 140 of either of the lighting systems 110a and 110b, as respectively shown in the examples illustrated in FIGS. 2A-2B. Also note that the extension length Δy, represented in the fourth column of Table 1, is a remaining portion of the short LED board of length L_{0b} that will be disposed in extension to the neighboring board, such that a remaining set of LEDs 225 distributed on this remaining portion will not be obstructed by the back of the neighboring board, as shown in the example illustrated in FIG. 4B. In this manner, light emitted by the remaining set of LEDs 225 distributed on the remaining portion will propagate to the lens 140 directly in the case of lighting system 110a illustrated in FIG. 2A, or through the optical coupler 130b in the case of lighting system 110b illustrated in FIG. 2B.

At 520, an optimum one from among the determined combinations that meets an optimization objective is selected. For example, a first optimization objective can be maximizing a number of LEDs that will be placed at the optimum distance H from the lens 140, or, equivalently, minimizing the extension length Δy. Note that this first optimum combination corresponds to a maximum excess length δy, or, equivalently, to a maximum amount of emitted LED light that cannot directly propagate to the lens 140 of either of the lighting systems 110a and 110b. For the first optimization objective, the selected first optimum combination is the one that has one long LED board of length L₀ₐ and four short boards of length L_{0b}, as shown in the second row of Table 1. In this case, the one long LED board of length L₀ₐ and three short LED boards of length L_{0b} will be supported by the first tray 210a at a distance H from the lens 140, and one short LED board of length L_{0b} will be supported by the second tray 210b at a distance H+Δz from the lens. Further for this first optimization objective, the next best optimum combination is the one that has no long LED board of length L₀ₐ, instead it has six short LED boards of length L_{0b}, as shown in the third row of Table 1. In this case, five short LED boards of length L_{0b} will be supported by the first tray 210a at a distance H from the lens 140, and one short LED board of length L_{0b} will be supported by the second tray 210b at a distance H+Δz from the lens.

As another example, a second optimization objective can be minimizing the amount of LED light that cannot directly propagate to the lens 140 of either of the lighting systems 110a and 110b, or, equivalently, minimizing the excess length δy. In this manner, this second optimum combination corresponds to a smallest number of obstructed LEDs that emit light that cannot propagate directly to the lens 140. For the second optimization objective, the selected second optimum combination is the one that has two long LED boards of length L₀ₐ and one short LED board of length L_{0b}, as shown in the first row of Table 1. In this case, the two long LED boards of length L₀ₐ will be supported by the first tray 210a at a distance H from the lens 140, and the short LED board of length L_{0b} will be supported by the second tray 210b at a distance H+Δz from the lens. Further for this second optimization objective, the next best optimum combination is the one that has no long LED board of length L₀ₐ, instead it has six short LED boards of length L_{0b}, as shown in the third row of Table 1. In this case, five short LED boards of length L_{0b} will be supported by the first tray 210a at a distance H from the lens 140, and one short LED board of length L_{0b} will be supported by the second tray 210b at a distance H+Δz from the lens.

As yet another example, a third optimization objective can be a weighted average of the first optimization objective and the second optimization objective. Here, a selected third optimum combination can be the one that has no long LED board of length L₀ₐ, instead it has six short LED boards of length L_{0b}, as shown in the third row of Table 1. In this case, five short LED boards of length L_{0b} will be supported by the first tray 210a at a distance H from the lens 140, and one short LED board of length L_{0b} will be supported by the second tray 210b at a distance H+Δz from the lens.

At 525, a determination is performed to verify whether the selected combination is available in stock. For instance, the determination performed at 525 can include accessing a data repository storing information relating to a number of available long LED boards of length L₀ₐ, another number of short LED boards of length L_{0b}, etc.

If the determination is negative, at 520′, in some implementations, a next optimum one from among the combinations determined at 520 that meets the previously used optimization objective is selected. In other implementations, an optimum one from among the combinations determined at 520 that meets another optimization objective, different from the previously used optimization objective is selected. Then, the determination at 525 is repeated. Alternatively, a predetermined time (e.g., 1 h, 4 h, 12 h, 1 day, 1 week, etc.) is simply allowed to pass before repeating the determination at 525. In the latter cases, the stock of LED boards may be replenished during the predetermined time.

If the determination performed at 525 is positive, an LED-based extension light source 200, like the one shown in FIG. 4B, is assembled, at 530, using the optimum combination of LED boards selected at 520 or at 520′.

In the above description, numerous specific details have been set forth in order to provide a thorough understanding of the disclosed technologies. In other instances, well known structures, and processes have not been shown in detail in order to avoid unnecessarily obscuring the disclosed technologies. However, it will be apparent to one of ordinary skill in the art that those specific details disclosed herein need not be used to practice the disclosed technologies and do not represent a limitation on the scope of the disclosed technologies, except as recited in the claims. It is intended that no part of this specification be construed to effect a disavowal of any part of the full scope of the disclosed technologies. Although certain embodiments of the present disclosure have been described, these embodiments likewise are not intended to limit the full scope of the disclosed technologies.

The preceding figures and accompanying description illustrate examples of systems and devices for illumination. It will be understood that these methods, systems, and devices are for illustration purposes only. Moreover, the described systems/devices may use additional parts, fewer parts, and/or different parts, as long as the systems/devices remain appropriate. In other words, although this disclosure has been described in terms of certain aspects or implementations and generally associated methods, alterations and permutations of these aspects or implementations will be apparent to those skilled in the art. Accordingly, the above description of examples of implementations does not define or constrain this disclosure. Further implementations are described in the following claims.

What is claimed is:

1. An illumination system comprising:
a housing;
a mount arranged inside the housing and elongated along a first direction, the mount having a first end and a second end separated along the first direction by a total length;
a first substrate having a first length shorter than the total length, the first substrate being coupled with the mount along the first direction such that an end of the first substrate aligns with the first end of the mount, the first substrate supporting a first circuit that includes light emitting diodes (LEDs) and a current regulator connected in series with each other, the LEDs of the first circuit being distributed along the first direction over the first length and disposed on the first substrate to emit, when the illumination system is operated, light in a second direction orthogonal to the first direction, the current regulator of the first circuit being configured to provide, when the illumination system is operated, constant current to the LEDs of the first circuit;
a second substrate having a second length longer than a difference between the total length and the first length, the second substrate being coupled with the mount (i) along the first direction such that an end of the second substrate aligns with the second end of the mount, and (ii) offset by a finite offset relative to the first substrate along the second direction, the second substrate supporting a second circuit that includes LEDs and a current regulator connected in series with each other, the LEDs of the second circuit distributed along the first direction over the second length and disposed on the second substrate to emit, when the illumination system is operated, light in the second direction, the current regulator of the second circuit being configured to provide, when the illumination system is operated, current regulation in the second circuit; and
a lens supported by the housing and extending along the first direction between the first and second ends of the mount, the lens being spaced apart, along the second direction, from the LEDs of the first circuit by a predefined spacing.

2. The illumination system of claim 1, wherein the finite offset is negative such that a portion of the first substrate distal from the first end of the housing
is between the lens and a portion of the second substrate distal from the second end of the housing over an overlap distance along the first direction, the overlap distance being equal to a difference between (i) the sum of the first length and the second length and (ii) the total length, and
blocks, during operation of the illumination system, light emitted by a set of the LEDs of the second circuit—that are distributed over the overlap distance of the second substrate—from reaching the lens.

3. The illumination system of claim 1, wherein the finite offset is positive such that a portion of the second substrate distal from the second end of the housing
is between the lens and a portion of the first substrate distal from the first end of the housing over an overlap distance along the first direction, the overlap distance being equal to a difference between the sum of the first length and the second length and the total length, and
blocks, during operation of the illumination system, light emitted by a set of the LEDs of the first circuit—that are distributed over the overlap distance of the first substrate—from reaching the lens.

4. The illumination system of claim 1, further comprising
an optical coupler arranged inside the housing and elongated along the first direction, the optical coupler being
disposed along the second direction between the first substrate and the lens, and
optically coupled with at least some of the LEDs of the first circuit.

5. The illumination system of claim 4, wherein the optical coupler extends between the first and second ends of the mount.

6. The illumination system of claim 4, wherein the optical coupler extends from the first end of the mount over the first length of the first substrate.

7. The illumination system of claim 4, wherein the optical coupler is optically coupled with the lens.

8. The illumination system of claim 1, further comprises
a first tray disposed on the mount, the first substrate being disposed on the first tray; and
a second tray disposed on the mount, the second substrate being disposed on the second tray, wherein a height offset of the first and second trays is equal to the finite offset.

9. The illumination system of claim 1, wherein the lens comprises a material transparent to the light emitted by the LEDs of the first and second circuits.

10. The illumination system of claim 1, wherein the lens has finite optical power.

11. A method comprising:
determining, from among a plurality of pre-specified light emitting diode (LED) board lengths of LED boards, two or more combinations of pre-specified LED board lengths, each of the LED boards including a corresponding LED circuit to be powered in constant current delivery method, each of the determined combinations
comprising an associated first number of LED boards of a first pre-specified LED board length and an associated second number of LED boards of a second pre-specified LED board length, and
having a combined length that is larger than a target length of a mount, such that a difference between the combined length and the target length is smaller than a shorter of the first pre-specified LED board length and the second pre-specified LED board length,
wherein each of the LED boards of the determined combination is to be coupled with the mount along a first direction;
selecting, from among the determined combinations, an optimum combination that meets an optimization criterion; and
coupling the LED boards of the optimum combination with the mount, wherein an LED board having the shorter of the first pre-specified LED board length and the second pre-specified LED board length is offset by a finite offset along a second direction orthogonal to the first direction with respect to the remaining LED boards of the optimum combination.

12. The method of claim 11, wherein the optimization criterion comprises maximizing the difference between the combined length of the optimum combination and the target length.

13. The method of claim 11, wherein the optimization criterion comprises minimizing the difference between the combined length of the optimum combination and the target length.

14. The method of claim 11, wherein the coupling of the LED boards of the optimum combination with the mount comprises
supporting the offset LED board on a first tray coupled with the mount, and
supporting the remaining LED boards of the optimum combination on a second tray coupled with the mount, wherein a separation of the first tray from the mount is smaller than a separation of second tray from the mount by the finite offset, and wherein a portion of the first tray is between a portion of the second tray and the mount.

15. The method of claim 14, further comprising
determining that the optimum combination is not available in stock; and
selecting, from among the determined combinations, a next optimum combination that meets the optimization criterion,
wherein the coupling of the LED boards of the optimum combination with the mount is performed using the selected next optimum combination.
